(19) United States
(12) Patent Application Publication
(10) Pub. No.: US 2025/0335217 A1
(43) Pub. Date: Oct. 30, 2025

(54) TRIGGER MECHANISM FOR GENERATING GRAPHICAL CAPTURES ENABLING DOWNSTREAM USER EXPERIENCES

(71) Applicant: MICROSOFT TECHNOLOGY LICENSING, LLC, Redmond, WA (US)

(72) Inventors: Leonardo Esteban BLANCO, Bellevue, WA (US); Juan Sebastian SEPULVEDA VARON, Vancouver, WA (US); Kyle Thomas KRAL, Redmond, WA (US); Nathan Peter POLLOCK, Woodinville, WA (US); Robert Armen MIKHAYELYAN, Seattle, WA (US); Nitesh PRABHU, Seattle, WA (US); Austin Bradley HODGES, Seattle, WA (US); Marisa Aida CANTU, Maple Valley, WA (US); Connor Colin Marwan AL-JOUNDI, Seattle, WA (US); Yohann PURI, Seattle, WA (US)

(21) Appl. No.: 18/650,565

(22) Filed: Apr. 30, 2024

(51) Int. Cl. G06F 9/451

(52) U.S. Cl. CPC G06F 9/451

(57) ABSTRACT

The techniques described herein provide systems for generating a record of user activity that enable downstream user experiences. Due to the significant portion of daily life that occurs via personal computing devices (e.g., laptops, personal computers, smartphones, tablets), service providers (e.g., operating system providers) may wish to enhance productivity and/or engagement through helpful user experiences. Moreover, such user experiences can be customized to a user's current context, preferences, and tendencies. Accordingly, the present system can, with the consent of the user, collect graphical captures recording a current state of a desktop environment at certain moments of interest. This is accomplished through a trigger mechanism utilizing operating system signals to intelligently collect graphical captures. In this way, the system captures the minimum or reduced amount of data to enable an accurate recollection of moments of interest in past user activity enabling efficient user experiences while respecting user privacy.

### BACKGROUND

More and more of daily life occurs through personal computing devices (e.g., laptops, tablets), from completing assignments for work and school to chatting with friends and family. As such, a user may utilize a diverse array of software applications to accomplish various tasks. Moreover, a given software application can be transformed by different contexts. For instance, an internet browser can be utilized to look up nearby restaurants at one moment and research information for a presentation at another moment. In turn, various service providers (e.g., operating system providers) may wish to offer dynamic user experiences that can enhance productivity and/or engagement. These dynamic user experiences can be tailored to user specific contexts, habits, and the like. Consequently, the service providers can implement systems to capture and analyze onscreen content to extract information such as text, images, and the like. In this way, the system can record a user's immediate context at a given time.

Such systems can enable helpful user experiences, such as a user activity recollection feature, that allow a user to organize and keep track of the large amount of information and content the user generates and/or interacts with on a daily basis. That is, the system can preserve a “memory” of a user's activity at a given moment while retaining contextual information that can help the user recall their experience of past activity. For example, a user may recall that they were working on a presentation at a given point in time. However, the user may not remember important moments pertaining to what they were specifically working on, such as creating a certain slide, looking up certain information, and so forth. By enabling the user to precisely recall past activity, such a system can provide an enriched and engaging user experience.

However, the process of capturing user activity can impose technical challenges and tradeoffs. For instance, some existing methods may record user activity all the time (e.g., via a constant screen recording) to capture a fully accurate recollection of past user activity. Unfortunately, such an approach can consequently result in increased resource consumption and potentially degrade the performance of the computing device. Moreover, the records of user activity are oftentimes stored locally on the computing device to respect user privacy and comply with local privacy regulations. As such, an overly detailed record of user activity can, over time, consume much of the user's storage space, further degrading the user experience.

It is with respect to these and other considerations that the disclosure made herein is presented.

### SUMMARY

The techniques described herein provide systems for generating a graphical capture of user activity for enabling downstream user experiences. As mentioned above, due to the significant portion of daily life that occurs via personal computing devices (e.g., laptops, personal computers, smartphones, tablets), service providers (e.g., operating system providers) may wish to enhance productivity and/or engagement through helpful user experiences. Such user experiences can be customized to a user's current context, preferences, and tendencies. As also mentioned above, these user experiences can be enabled by collecting, with the consent of the user, a record of user activity such as a graphical capture (e.g., a screenshot) of a desktop environment. Generally described, a desktop environment is a graphical user interface abstraction of an operating system that enables a user to intuitively interact with software applications on a computing device.

However, the process of generating graphical captures can impose certain technical challenges and tradeoffs. For example, some existing methods may simply record user activity all the time (e.g., via a constant screen recording) to enable a full and accurate recollection of moments of interest in past user activity. Unfortunately, such an approach can result in increased resource consumption and potentially degrade the performance of the computing device and thus the user experience. Furthermore, records of user activity are typically stored locally on the computing device to respect user privacy and comply with local privacy regulations. Consequently, an overly detailed record of user activity can, over time, consume much of the user's storage space, further degrading the user experience.

As such, a technical challenge addressed in the present disclosure is to capture the minimum or reduced amount of data to enable an accurate recollection of moments of interest in past user activity. To achieve this, the present techniques implement various triggers that leverage operating system-level signals to cause a system to capture user activity. In the context of the present disclosure, a trigger is an explicit signal from a user experience (e.g., an application) to capture user activity. In a specific example, capturing user activity comprises generating a graphical capture (e.g., a screenshot) of on-screen content. For instance, a graphical capture can define a software application that is currently in-focus within the desktop environment. That is, while the user may have multiple software applications open, the user may interact with a single software application, or be determined by the system to interact with the single software application, at a given moment. This software application is accordingly said to be “in-focus”.

The graphical capture can then be provided to a downstream graphical capture consumer for use in various user experiences. In a specific example, the data consumer is an artificial intelligence (AI) visual analysis tool that identifies onscreen content such as text, image, video, and so forth. Generally described, the system begins by detecting an operating system-level change at the computing device. Within the context of the present disclosure, an operating system-level change is any input to the computing device that causes a change to a component of the operating system, such as keystrokes, movement with a pointing device (e.g., a mouse), toggling a device setting, a changing network status, saving a file, and so forth.

The operating system-level change is categorized based on the operating system component that is affected by the operating system-level change. For example, a user may navigate to a new website causing a visual change of content that is displayed onscreen. As such, navigating to a new website can be categorized as an “onscreen content” type change. In another example, the user may highlight and copy a portion of text from the new website to their clipboard. In response, this change can be categorized as a “user input” type change.

The system can then quantify the operating system-level change utilizing a quantification mechanism that is selected based on the operating system component that was affected by the operating system-level change. That is, the mechanism for quantifying a change to on-screen content can be different from another mechanism for quantifying a user input. For example, quantifying a change to onscreen content can be accomplished by generating a first set of embeddings from the onscreen content and a second set of embeddings from an updated onscreen content (e.g., when a user loads a new webpage). Generally described, embeddings are numerical representations (e.g., a vector) of a piece of information (e.g., text, images, audio). In this way, the difference between the onscreen content and the updated onscreen content can be quantified by comparing the embeddings for each and calculating a difference. In another example, a user input can be quantified by identifying the specific user inputs such as keystrokes, button presses, tour inputs, pointer movements, and so forth.

Once quantified, the system can then determine that the operating system-level change satisfies a threshold level of change that is calculated for the operating system component that is affected by the operating system-level change. Consider again the examples mentioned above. For embeddings of onscreen content, the threshold level of change can be a threshold amount of difference between the first set of embeddings and the second set of embeddings. For user inputs, the threshold level of change can be determined by comparing the identified user inputs against a library of common user inputs such as copy/paste keyboard shortcuts, a screenshot keyboard shortcut, highlighting text, and so forth.

In response to determining that the quantified operating system-level change satisfies the threshold level of change, the system then triggers a graphical capture of the desktop environment recording a current state of the desktop environment. As mentioned above, the graphical capture can represent the current visual layout of the desktop environment such as open software applications, content that the user is currently viewing (e.g., websites, documents), and the like.

Accordingly, the graphical capture can be provided to a graphical capture consumer to enable downstream user experiences. In a specific example, the graphical capture consumer is an artificial intelligence model that can identify and extract information from the graphical capture such as which software application is in focus, what content the user was viewing, and what actions the user took at the time of the graphical capture. In this way, the graphical captures can enable helpful features such as user activity recall that improve productivity and/or engagement.

In one example of a technical benefit of the present disclosure, utilizing operating system-level signals to trigger graphical capture generation enables the system to capture the minimum or reduced amount of data to enable an accurate recollection of moments of interest in past user activity. That is, the system may capture moments the user may wish to return to at a later point in time. Consequently, as records of user activity (e.g., graphical captures) are stored, e.g., locally at the computing device to respect user privacy, minimizing data collection accordingly minimizes the amount of storage consumed by the graphical captures. As such, minimizing the storage consumed by the graphical captures can directly translate to minimizing impact on the general user experience of the computing device.

In another example of a technical benefit of the present disclosure, the triggers used to cause the generation of graphical captures can be customized by the user (e.g., via user settings) and/or automatically. That is, various triggers can be enabled and/or disabled based on user preferences, user habits, and so forth. For instance, an onscreen content trigger can be disabled when a user visits a particular webpage. In a specific example, the user may configure the system to disable graphical captures when viewing sensitive information such as financial information. In this way, the system can further respect user privacy and data sensitivity in contrast to some existing approaches which simply record all user activity.

In still another example of a technical benefit of the present disclosure, minimizing the data collected as mentioned above enables enhanced efficiency when analyzing user activity. That is, when searching through and/or organizing graphical captures, reducing the volume of data to process naturally leads to faster searches. In this way, collecting the minimum or reduced amount of data to form an accurate recollection of moments of interest in past user activity enhances productivity and/or engagement by enabling fast and responsive user experiences.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for triggering a generation of a graphical capture of a desktop environment of a computing device.

FIG. 2 illustrates an example of an onscreen content type trigger for causing generation of a graphical capture.

FIG. 3 illustrates an example of a user input type trigger for causing generation of a graphical capture.

FIG. 4 illustrates an example of an internal operation type trigger for causing generation of a graphical capture.

FIG. 5 is a flow diagram showing aspects of a process for utilizing operating system-level signals to trigger generation of graphical captures of a desktop environment of a computing device.

FIG. 6 is a computer architecture diagram illustrating an illustrative computer hardware and software architecture for a computing system capable of implementing aspects of the techniques and technologies presented herein.

### DETAILED DESCRIPTION

The techniques described herein provide a system for generating a record of user activity for enabling downstream user experiences. As mentioned above, due to the significant portion of daily life that occurs via personal computing devices (e.g., laptops, personal computers, smartphones, tablets), service providers (e.g., operating system providers) may wish to enhance productivity and/or engagement through helpful user experiences. Such user experiences can be customized to a user's current context, preferences, and tendencies. As also mentioned above, these user experiences can be enabled by collecting, with the consent of the user, a record of user activity such as a graphical capture (e.g., a screenshot) of a desktop environment. Moreover, the present techniques enable systems to capture the minimum or reduced amount of data to enable an accurate recollection of moments of interest in past user activity leading to improved efficiency, reduced storage consumption, and enhanced user data privacy.

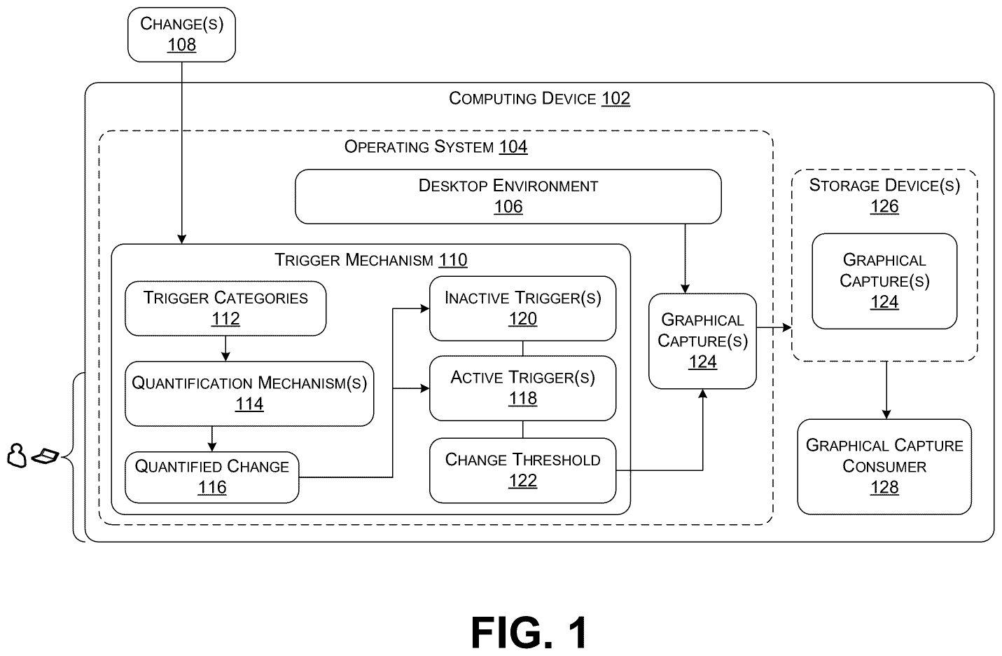

Various examples, scenarios, and aspects related to the techniques are described below with respect to FIGS. 1-6.

FIG. 1 illustrates a computing device 102 (e.g., a laptop, a personal computer, a smartphone, a tablet) having an operating system 104 installed that is configured to capture a record of user activity within a desktop environment 106 in the manner briefly described above. As mentioned above, a desktop environment 106 is a graphical user interface abstraction of an operating system that enables a user to intuitively interact with software applications on a computing device. In operation, the computing device 102 can receive a change 108 at the operating system 104. The change 108 can include any input to one or more components of the operating system 104, such as a rendering of onscreen content, a signal from a user input device (e.g., a keyboard, a mouse, a touchscreen), a file system update, a network status, and so forth. As such, the change 108 is referred to herein as an operating system-level change.

The change 108 is processed by the operating system 104 using a trigger mechanism 110. As shown, the trigger mechanism 110 can include various trigger categories 112 to categorize the change 108 based on which component of the operating system 104 was affected by the change 108. For example, a series of keystrokes can be categorized under the trigger categories 112 as a “user input” type change. In another example, loading a new webpage can be categorized under the trigger categories 112 as an “onscreen content” type change. In a third example, a user saving a file and/or creating a new file can be categorized under the trigger categories 112 as an “internal operation” type change. It should be understood that the trigger mechanism 110 can define any number of trigger categories 112 to capture the diversity of possible types of the change 108.

The trigger mechanism 110 can further define a quantification mechanism 114 for additional processing of a change 108. In various examples, the quantification mechanism 114 is selected based on the categorization of the change 108 under the trigger categories 112. That is, a “user input” type change and an “onscreen content” type change can be accordingly processed by different quantification mechanisms 114. Stated another way, changes 108 of different trigger categories 112 can be quantified utilizing different methods.

To illustrate this, consider again the examples mentioned above. For a “user input” type change, the quantification mechanism 114 can be configured to recognize certain patterns of user inputs and/or actions, such as keyboard shortcuts (e.g., copy-paste), pointer movement (e.g., with a mouse), and the like. For an “onscreen content” type change, the quantification mechanism 114 may be an artificial intelligence (AI) embedding model that is configured to generate embeddings of onscreen content (e.g., text, images, webpages). Specific examples of embedding models include principal component analysis (PCA), singular value decomposition (SVD), and WORD2VEC by GOOGLE. Techniques such as principal component analysis and singular value decomposition are dimensionality reduction techniques that transform data from a high-dimensional representation (e.g., rendered text and images) to a low-dimensional representation (e.g., a numerical vector). The low-dimensional representation retains at least some of the meaningful properties of the original high-dimensional representation. In another example, techniques such as WORD2VEC utilize a shallow neural network to learn word associations from a training dataset containing a large corpus of words. As such, the WORD2VEC model can be configured to predict a target word from a given context using a continuous bag of words (CBOW) approach or, conversely, predict a context from a given target word via the skip-gram approach. While specific techniques for generating embeddings are mentioned herein, it should be understood that any suitable method can be used to generate embeddings from onscreen content.

As mentioned above, embeddings are numerical representations of content that enable computational analysis such as by another artificial intelligence model. For an “internal operation” type change, which may result in little or no visual change in the desktop environment 106, the quantification mechanism 114 can be configured to poll the affected operating system component to determine the action accomplished by the change such as opening a file, toggling a device setting, saving a file, playing and/or pausing audio, and so forth.

As a result of processing by the quantification mechanism 114, the change 108 becomes a quantified change 116 that can undergo analysis by the trigger mechanism 110 in accordance with specific active triggers 118 and/or inactive triggers 120. Generally described, a trigger is a condition that, when met, sends an explicit signal to capture a record of user activity in the desktop environment 106. Consequently, triggers can be configured to capture the record of user activity at certain moments of interest to minimize data collection. That is, triggers can represent moments that the user may wish to return to at a later time.

Some examples of triggers include a timer which causes a capture at regular time intervals (e.g., every five seconds) in which the change 108 is an elapsed time period and the quantified change is the number of seconds in the elapsed time period. A more sophisticated trigger can detect certain keyboard shortcuts such as copy/paste, a screenshot shortcut, and/or a user configured shortcut to capture the current moment. In another example, a trigger can detect certain user actions within the desktop environment such as minimizing and/or maximizing a software application, toggling a device setting (e.g., muting/unmuting a microphone), moving a pointer through the desktop environment 106, an eye gaze towards certain portions of the desktop environment, a voice input, a particular keyboard shortcut, and so forth. In still another example, a trigger can be based on an analysis of onscreen content via numerical representations of onscreen content such as the embeddings mentioned above. In still another example, the trigger mechanism 110 can be exposed to other entities by way of a trigger application programming interface (API) to enable standalone applications within the operating system 104 to define and capture their own moments of interest. In a specific example, a standalone application generates a signal that is directed to the trigger application programming interface. Accordingly, the signal defines a command to the trigger application programming interface to generate a graphical capture.

In various examples, certain triggers can be manually and/or automatically configured as active triggers 118 or inactive triggers 120. For instance, the trigger mechanism 110 may determine that a user typically does not utilize a particular keyboard shortcut and in response, the trigger mechanism 110 can configure a trigger associated with the particular keyboard shortcut as an inactive trigger 120. Conversely, the trigger mechanism 110 may determine that an infrequently used keyboard shortcut indicates an important moment that is worth capturing in the event the keyboard shortcut is used. As such, the trigger associated with the keyboard shortcut can be configured as an active trigger 118. In addition, the active triggers 118 and/or the inactive triggers 120 can also be manually customized by user preferences.

In addition, active triggers 118 can transition to inactive triggers 120 in response to certain conditions and/or user context within the desktop environment 106. For instance, the user may be viewing personal financial information on a banking website. In response, an active trigger 118 associated with onscreen content may transition to an inactive trigger 120 to prevent capturing sensitive information and respect the privacy of the user. In another example, the user may be playing a video game in which certain sequences of user inputs to perform actions in-game may match certain active triggers 118 that apply outside of the video game. As such, the trigger mechanism 110 can transition these active triggers 118 to inactive triggers 120 when the user launches the video game. Moreover, dynamically disabling some or all of the trigger mechanism 110 can reduce resource consumption during particularly demanding tasks such as gaming.

Furthermore, the trigger mechanism 110 can be configured to learn user habits and/or tendencies over time to intelligently configure the active triggers 118. In a specific example, the trigger mechanism 110 learns that certain location changes are more likely to represent a moment of interest for graphical capture. Specifically, the trigger mechanism can utilize a location service to configure an active trigger 118 for capturing user activity based on a location change. For instance, the trigger mechanism 110 can determine, via the location service, that a user tends to leave home and head to an office for work around the same time each day indicating a potential moment of interest for graphical capture. Accordingly, the trigger mechanism 110 can configure an active trigger 118 to capture user activity in response to a location change from a home location to a work location. Consequently, a location change from the home location to a café can be excluded from the active trigger 118.

In another example, the trigger mechanism 110 can learn that certain changes to input modalities are more likely to represent a moment of interest for graphical capture. That is, the trigger mechanism 110 can differentiate types of input modality changes to intelligently configure an active trigger 118. For instance, the trigger mechanism 110 can learn that a user typically switches from a mouse and keyboard input modality to a stylus pen input modality to continue using mouse functions, such as scrolling and clicking. The trigger mechanism 110 can also learn that the user occasionally switches from the mouse and keyboard input modality to the stylus pen input modality to handwrite text. As such, despite detecting the same operating system-level change (e.g., switching to the stylus pen input modality) the trigger mechanism 110 can differentiate the context of the change and configure the active trigger 118 to provide different outcomes. For example, capturing user activity when handwriting text and not capturing user activity when using mouse functions.

In conjunction with the active triggers 118, the trigger mechanism 110 can include a change threshold 122 to determine when to capture a record of user activity. In some examples, the change threshold 122 can be a binary value such as determining whether a device setting was toggled on or off, determining whether a sequence of user inputs matches a predetermined sequence, and the like. Alternatively, the change threshold 122 can be a predefined quantity such as a threshold number of seconds that have elapsed, a threshold level of difference calculated between a first set of embeddings and a second set of embeddings, and so forth.

In the event a quantified change corresponds to an active trigger 118 and satisfies the change threshold 122, the trigger mechanism 110 causes the operating system 104 to generate a graphical capture 124 of the desktop environment 106. In examples, the graphical capture 124 is stored locally within a storage device 126 of the computing device 102. From the storage device 126, a graphical capture consumer 128 can access the graphical capture 124 for use in downstream user experiences such as activity recall. As mentioned above, to respect user privacy and/or comply with data privacy regulations, the graphical captures 124 may be stored locally to the computing device 102 and may not be transmitted to any entities outside of the computing device 102.

In a further example, some operations of the trigger mechanism 110 can be performed asynchronously. That is, while a user may navigate to a new website at a given time, the resultant change 108 may be processed at a later point in time. As mentioned above, onscreen content can be analyzed by an artificial intelligence model to generate embeddings numerically representing the onscreen content. However, such artificial intelligence models can be computationally intensive. This can especially be true for consumer computing devices (e.g., laptops, tablets, smartphones). As such, the trigger mechanism 110 can intelligently defer the artificial intelligence analysis to a later point in time when computing resource availability increases (e.g., when the computing device 102 is idle). Accordingly, the trigger mechanism 102 can generate a graphical capture 124 that is held in a temporary storage (e.g., a separate location in the storage device 126). At a later point in time, the graphical capture 124 can be retrieved from the temporary storage by the trigger mechanism 110 to be analyzed using the artificial intelligence model. Accordingly, the trigger mechanism 110 can then determine whether to discard the graphical capture 124 or retain the graphical capture 124 for provision to the graphical capture consumer 128.

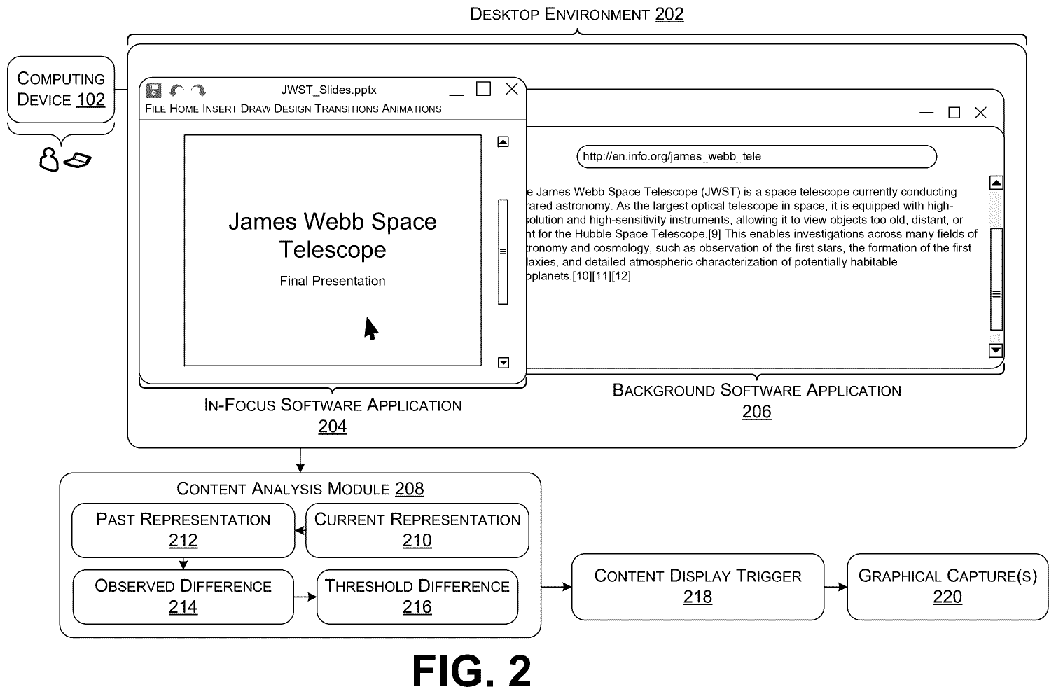

Turning now to FIG. 2, aspects of an example desktop environment 202 of a computing device 102 that is configured to capture a record of user activity in response to certain triggers are shown and described. In particular, FIG. 2 illustrates an example of an onscreen content type trigger for causing generation of a graphical capture. In the present example, consider a scenario in which a user has created a presentation on the James Webb Space Telescope as shown in the in-focus software application 204 (a presentation editor). At a prior point in time, the user looked up information on the James Webb Space Telescope as shown in the background software application 206 (a web browser). That is, the background software application 206 was previously in-focus and the user has since launched the in-focus software application 204 to begin working on the presentation.

Consequently, launching the in-focus software application 204 causes an operating system-level change that initializes the in-focus software application 204 and transitions the background software application 206 from the foreground to the background. As such, the computing device 102 (by way of the operating system) can categorize this change as an “onscreen content” type change via the trigger categories 112 as described above with respect to FIG. 1. In response, the computing device 102 calls a content analysis module 208 to quantify the extent of the visual change within the desktop environment 202 caused by the in-focus software application 204. In various examples, the content analysis module 208 corresponds to the quantification mechanism 114 as discussed above with respect to FIG. 1.

To quantify the current visual state of the desktop environment 202, the content analysis module 208 can generate a current representation 210 of the desktop environment 202. In a specific example, the current representation 210 is an embedding comprising a numerical representation of the content displayed within the desktop environment 202 (e.g., text, images). More specifically, an embedding captures the semantic meaning of a given piece of information such as text. In another example, the current representation 210 is a contour map of the content displayed within the desktop environment 202. In still another example, the current representation 210 is text extracted from the content displayed within the desktop environment 202 by optical character recognition (OCR). In this way, the content analysis module 208 can detect changes in the meaning of onscreen content in addition to visual changes to the onscreen content. Likewise, lexical changes can be detected from an analysis text in isolation from the visual presentation of onscreen content. In a further example, a precomputed image hash heuristic can be utilized for visual change detection within onscreen content. However, it should be understood that the content analysis module 208 can utilize any suitable method to quantify the display of onscreen content, including extracting text from an underlying file, retrieving rendered text from a rendering stack, and so forth.

Accordingly, the current representation 210 can be compared against a past representation 212 that captures a prior moment in time. For instance, the past representation 212 may have been generated at a moment in which the in-focus software application 204 had not yet been launched. Like the current representation 210, the past representation 212 can be an embedding comprising a numerical representation of onscreen content, a contour map, or any other suitable representation. However, to enable comparison, it should be understood that the past representation 212 and the current representation 210 may utilize the same quantification method (e.g., embeddings, contour maps). Some techniques for generating such representations 210 and 212 include the WORD2VEC by GOOGLE, FASTTEXT by META PLATFORMS, and term frequency-inverse document frequency (TF-IDF).

By comparing the current representation 210 and the past representation 212, the content analysis module 208 can calculate an observed difference 214. In a specific example, in which the current representation 210 is a first embedding and the past representation 212 is a second embedding, the content analysis module 208 calculates the distance between the first embedding and the second embedding via a dot product of two vectors. The observed difference 214 can then be compared against a threshold difference 216 to determine whether the desktop environment 202 has changed enough to warrant recording. Stated another way, the threshold difference 216 establishes a threshold level of change that must occur to trigger a graphical capture. In the event the observed difference 214 satisfies the threshold difference 216, indicating that a sufficient level of change has occurred, the content analysis module 208 can activate a content display trigger 218 to generate a graphical capture 220. In this way, the computing device 102 can generate graphical captures 220 that enable helpful downstream user experiences such as recalling past activity. By introducing additional intelligence to the process of collecting user activity and generating graphical captures 220, the present techniques enable an accurate record of past user activity while minimizing the volume of data collected.

In various examples, it should be understood that that the content analysis module 208 can be an artificial intelligence model that is configured to periodically quantify and compare onscreen content (e.g., every five seconds). Alternatively, and/or additionally, the content analysis module 208 can be configured to perform onscreen quantification and comparison in response to user activity. That is, the content analysis module 208 can be dormant when the desktop environment 202 is idle.

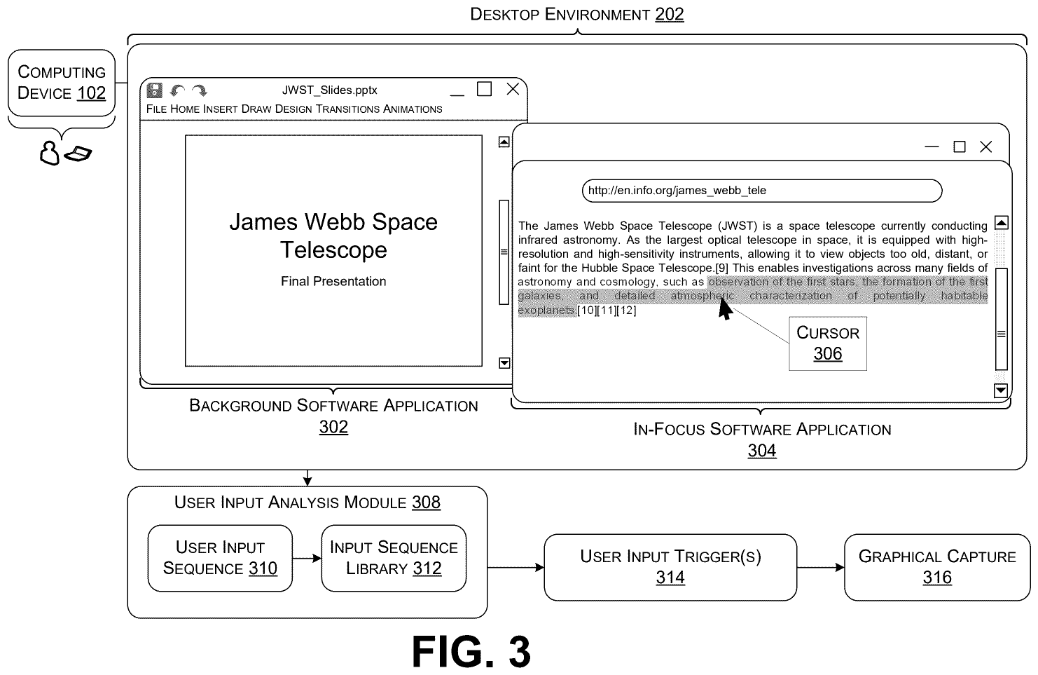

Turning now to FIG. 3, additional aspects of an example desktop environment 202 of a computing device 102 that is configured to capture a record of user activity in response to certain triggers are shown and described. In particular, FIG. 3 illustrates an example of a user input type trigger for causing generation of a graphical capture. As shown in FIG. 3, the user, having created a presentation has switched from the presentation editor back to the web browser. Consequently, the presentation editor is now a background software application 302 while the web browser is an in-focus application 304. Moreover, the user utilizes a cursor 306 to highlight a portion of text displayed within the in-focus software application 304 as shown by the shading over the text in the in-focus software application 304. The user can then copy the highlighted text to their clipboard via a keyboard shortcut or any other method (e.g., a mouse click, a touch input, a voice command). In the present example, highlighting the text with the cursor 306 and/or copying the text can be considered an operating system-level change. Accordingly, the computing device 102 (by way of the operating system) can categorize the operating system-level change as a “user input” type change via the trigger categories 112 as described above with respect to FIG. 1.

Accordingly, the computing device 102 calls a user input analysis module 308 to quantify the change introduced by highlighting and copying the text as shown. In the present example, the user input analysis module 308 corresponds to the quantification mechanism 114 as discussed above with respect to FIG. 1. In a specific example, the user input analysis module 308 determines a user input sequence 310 in which the user moved the cursor 306 across the desktop environment 202 to highlight the portion of text and pressed a keyboard shortcut to copy highlighted text (e.g., “ctrl+c”).

As such, the user input analysis module 308 can compare the user input sequence 310 against an input sequence library 312. In various examples, the input sequence library 312 specifies certain user inputs that, when executed, typically indicate that a user is interested in some aspect of the displayed desktop environment 202. Some specific examples of entries in input sequence library 312 include copying and/or pasting content, taking a screenshot of the desktop environment, playing and/or pausing audio, muting and/or unmuting a microphone, enabling and/or disabling a webcam, directing a gaze to a particular portion of the desktop environment 202 and so forth. It should be understood that a screenshot that is manually taken by a user (e.g., via a keyboard shortcut) can differ from the automatically generated graphical captures. In various examples, a manual screenshot may only capture a portion of the desktop environment 202. Moreover, the manual screenshot may lack certain aspects of the graphical capture that enable downstream user experiences such as data identifying an in-focus application 304, timestamp data, and the like.

In the event the user input sequence 310 matches an entry in the input sequence library 312, the user input analysis module 308 activates a user input trigger 314 corresponding to the entry of the input sequence library 312 to generate a graphical capture 316 that records the current state of the desktop environment 202. That is, there may be a user input trigger 314 corresponding to each entry of the input sequence library 312. Stated another way, determining that the user input sequence 310 matches an entry of the input sequence library 312 corresponds to determining that a quantified operating system-level change represented by the user input sequence 310 satisfies a threshold level of change represented by the input sequence library 312. In response, the computing device generates the graphical capture 316 recording the current state of the desktop environment 202. By capturing the moment at which the user copied the highlighted text, the graphical capture 316 can enable the user to return to the source of their information at a later point in time without requiring the user to manually recall the source.

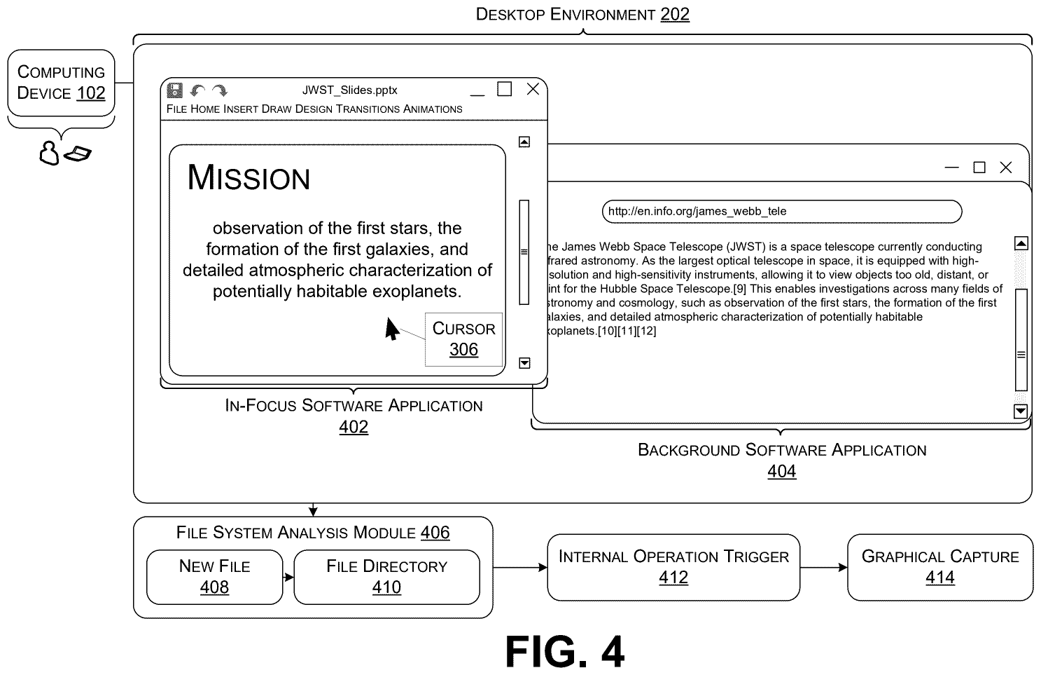

Turning now to FIG. 4, additional aspects of an example desktop environment 202 of a computing device 102 that is configured to capture a record of user activity in response to certain triggers are shown and described. In particular, FIG. 4 illustrates an example of an internal operation type trigger for causing generation of a graphical capture. As shown in FIG. 4, the user, having copied the text as shown above, has switched back from the web browser to the presentation editor. Consequently, the presentation editor is once again an in-focus software application 402 while the web browser is a background application 404. As also shown in FIG. 4, the user pastes the copied text into their presentation in the in-focus software application 402. The user can then save their progress on the presentation via a keyboard shortcut, a button press, a speech command or other method.

Consequently, saving the presentation can introduce an operating system-level change at the file system of the computing device 102. While this change does not introduce very much, if any, visual change within the desktop environment 202, saving a presentation for the first time can represent a moment of interest that the user may wish to return to at a later point in time. Accordingly, the computing device 102 (by way of the operating system) can categorize this change as an “internal operation” type change via the trigger categories 112 as described above. In response, the computing device 102 can call a file system analysis module 406 to quantify the change introduced by saving the presentation. For a newly created presentation, such as the one shown in FIG. 4, saving the presentation causes an operating system-level change at the file system that produces a new file 408 at a given file directory 410. Conversely, saving progress in an existing file can cause an operating system-level change at the file system that produces a file update signal rather than a new file 408.

In the present example, the file system analysis module 406 corresponds to the quantification mechanism 114 as discussed above with respect to FIG. 1. As such, detecting a new file 408 at the file directory 410 can correspond to determining that the operating system-level change introduced by saving the presentation satisfies a threshold level of change. In response, the file system analysis module 406 can activate an internal operation trigger 412 to cause generation of a graphical capture 414. In this way, the graphical capture 414 records the moment at which the user saves the presentation for the first time despite little to no visual change having occurred. As such, the trigger mechanism described herein can account for diverse scenarios in which a moment of interest may occur thereby enabling helpful downstream user experiences such as recalling past activity, insightful trends, and so forth.

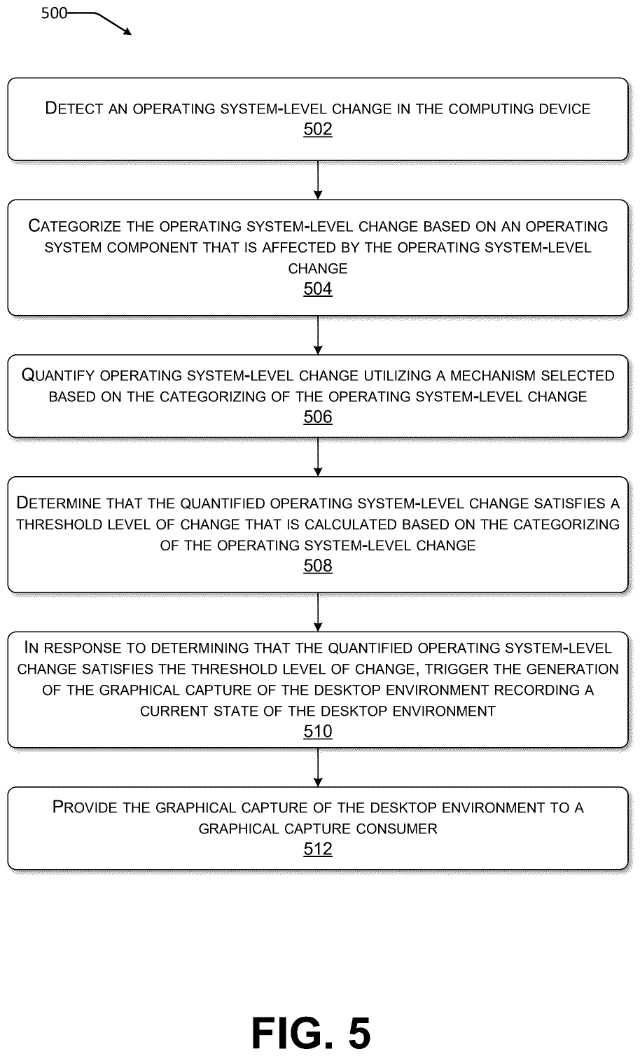

Turning now to FIG. 5, aspects of a process 500 for utilizing operating system-level signals to trigger generation of graphical captures of a desktop environment of a computing system are shown and described. With respect to FIG. 5, the process 500 begins at operation 502 where a system detects an operating system-level change in the computing device. As described above, the operating system-level change can include changes to onscreen content, a sequence of user inputs, a network status, a device setting, and update to the file system, and so forth.

Then, at operation 504, the system categorizes the operating system-level change based on an operating system component that is affected by the operating system-level change. For instance, a user may navigate to a new website causing a visual change of content that is displayed onscreen. As such, navigating to a new website can be categorized as an “onscreen content” type change. In another example, the user may highlight and copy a portion of text from the new website to their clipboard. In response, this change can be categorized as a “user input” type change.

Next, at operation 506, the system quantifies the operating system-level change utilizing a mechanism selected based on the categorizing of the operating system-level change. As discussed above, different types of changes can be quantified in different ways. For example, an “onscreen content” type change can be quantified by generating embeddings comprising a numerical representation (e.g., a vector) capturing the semantic meaning of the onscreen content.

Proceeding to operation 508, the system determines that the quantified operating system-level change satisfies a threshold level of change that is calculated based on the categorizing of the operating system-level change. In a specific example, consider an “onscreen content” type change in which the change is quantified using a numerical embedding. Accordingly, determining that the change satisfies a threshold level change can comprise comparing the embedding against a past embedding representing an earlier point in time and calculating an observed difference then comparing the observed difference against a threshold difference.

Then, at operation 510, in response to determining that the quantified operating system-level change satisfies the threshold level of change, the system triggers the generation of the graphical capture of the desktop environment recording a current state of the desktop environment. As described above, triggering generation of graphical captures in this way enables the system to capture the minimum or reduced amount of data to enable an accurate recollection of moments of interest in past user activity. In this way, the system enables more efficient search, respects user privacy, and since graphical captures are stored locally, reduces storage consumption.

Finally, at operation 512, the system provides the graphical capture to a graphical capture consumer. As mentioned above, graphical capture consumers can be any entity that utilizes the graphical capture to enable various user experiences and/or features. In a specific example, the graphical capture consumer is an automated visual analysis tool that identifies the content present in a graphical capture to organize user activity recollection features.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can begin and/or end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 500 can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 500 may also be implemented in other ways. In addition, one or more of the operations of the process 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

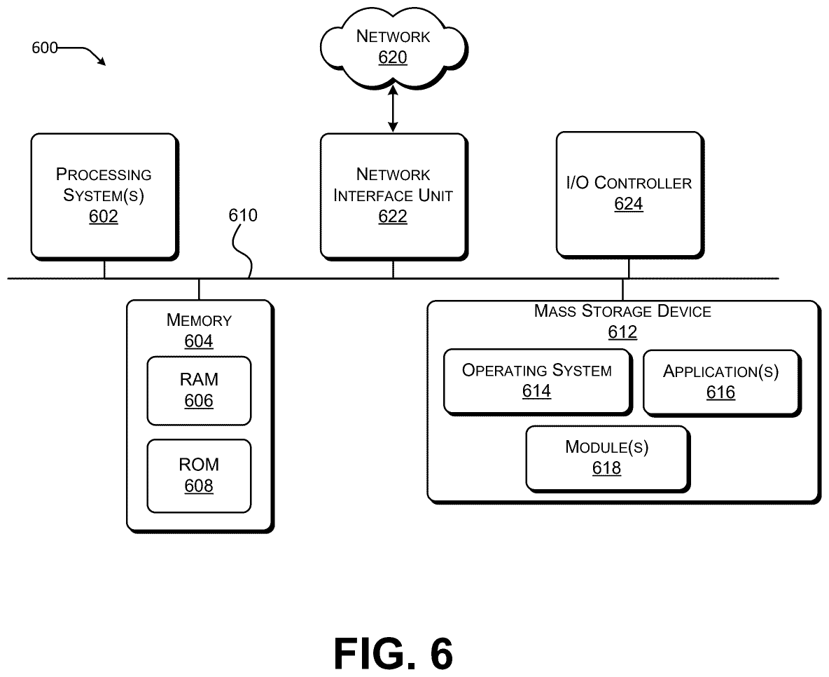

FIG. 6 shows additional details of an example computer architecture 600 for a device, capable of executing computer instructions (e.g., a module or a program component described herein). The computer architecture 600 illustrated in FIG. 6 includes processing system 602, a system memory 604, including a random-access memory 606 (RAM) and a read-only memory (ROM) 608, and a system bus 610 that couples the memory 604 to the processing system 602. The processing system 602 comprises processing unit(s).

Processing unit(s), such as processing unit(s) of processing system 602, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing system 602 through a mass storage controller connected to the bus 610. The mass storage device 612 and its associated computer-readable media provide non-volatile storage for the computer architecture 600. Although the description of computer-readable media contained herein refers to a mass storage device, the computer-readable media can be any available computer-readable storage media or communication media that can be accessed by the computer architecture 600.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

The software components described herein may, when loaded into the processing system 602 and executed, transform the processing system 602 and the overall computer architecture 600 from a general-purpose computing system into a special-purpose computing system customized to facilitate the functionality presented herein. The processing system 602 may be constructed from any number of transistors or other discrete circuit elements, which may individually or collectively assume any number of states. More specifically, the processing system 602 may operate as a finite-state machine, in response to executable instructions contained within the software modules disclosed herein. These computer-executable instructions may transform the processing system 602 by specifying how the processing system 602 transition between states, thereby transforming the transistors or other discrete hardware elements constituting the processing system 602.

The disclosure presented herein also encompasses the subject matter set forth in the following clauses.

Example Clause A, a method for triggering a generation of a graphical capture of a desktop environment of a computing device comprising: detecting an operating system-level change in the computing device; categorizing the operating system-level change based on an operating system component that is affected by the operating system-level change; quantifying the operating system-level change utilizing a mechanism selected based on the categorizing of the operating system-level change; determining that the quantified operating system-level change satisfies a threshold level of change that is calculated based on the categorizing of the operating system-level change; in response to determining that the quantified operating system-level change satisfies the threshold level of change, triggering the generation of the graphical capture of the desktop environment recording a current state of the desktop environment; and providing the graphical capture of the desktop environment to a graphical capture consumer.

Example Clause B, the method of Example Clause A, wherein: the operating system-level change is an elapsed time period; the quantified operating system-level change is a number of seconds of the elapsed time period; the threshold level of change is a predefined number of seconds; and determining that the quantified operating system-level change satisfies the threshold level of change comprises determining that the number of seconds of the elapsed time period is greater than or equal to the predefined number of seconds.

Example Clause C, the method of Example Clause A, wherein the operating system-level change is a changed content that is displayed on the computing device.

Example Clause D, the method of Example Clause C, wherein: the quantified operating system-level change is a numerical representation of the changed content that is displayed on the computing device; the threshold level of change is a predefined difference between the numerical representation of the changed content that is displayed on the computing device and a numerical representation of a previously displayed content; and determining that the quantified operating system-level change satisfies the threshold level of change comprises determining that a difference between the numerical representation of the changed content and the numerical representation of a previously displayed content is greater than or equal to the predefined difference.

Example Clause E, the method of Example Clause C, wherein: the quantified operating system-level change is a contour map of the changed content that is displayed on the computing device; the threshold level of change is a predefined difference between the contour map of the changed content that is displayed on the computing device and a contour map of a previously displayed content; and determining that the quantified operating system-level change satisfies the threshold level of change comprises determining that a difference between the contour map of the changed content and the contour map of a previously displayed content is greater than or equal to the predefined difference.

Example Clause F, the method of Example Clause A, wherein: the operating system-level change is a user input; the quantified operating system-level change is a sequence of user inputs; the threshold level of change is a predefined sequence of user inputs; and determining that the quantified operating system-level change satisfies the threshold level of change comprises determining that the sequence of user inputs matches the predefined sequence of user inputs.

Example Clause G, the method of Example Clause A, wherein: the operating system-level change is an application signal; the quantified operating system-level change comprises determining that the application signal is directed to a trigger application programming interface; the threshold level of change is a command to the trigger application programming interface to generate a graphical capture; and determining that the quantified operating system-level change satisfies the threshold level of change comprises determining that the application signal that is directed to the trigger application programming interface is the command to the trigger application programming interface to generate the graphical capture.

Example Clause H, the method of any one of Example Clause A through G, wherein the operating system-level change is detected in accordance with a predefined set of triggers.

Example Clause I, the method of Example Clause H, wherein the predefined set of triggers is configured by a user preference of the computing device.

Example Clause J, the method of Example Clause H, wherein the predefined set of triggers is automatically configured based on an analysis of user activity.

Example Clause K, a system for triggering a generation of a graphical capture of a desktop environment of a computing device comprising: a processing system; and a computer-readable medium having instructions encoded thereon that when executed by the processing system cause the system to perform operations comprising: detecting an operating system-level change in the computing device; categorizing the operating system-level change based on an operating system component that is affected by the operating system-level change; quantifying the operating system-level change utilizing a mechanism selected based on the categorizing of the operating system-level change; determining that the quantified operating system-level change satisfies a threshold level of change that is calculated based on the categorizing of the operating system-level change; in response to determining that the quantified operating system-level change satisfies the threshold level of change, triggering the generation of the graphical capture of the desktop environment recording a current state of the desktop environment; and providing the graphical capture of the desktop environment to a graphical capture consumer.

Example Clause L, the system of Example Clause K, wherein the operating system-level change is a changed content that is displayed on the computing device.

Example Clause M, the system of Example Clause L, wherein: the quantified operating system-level change is a numerical representation of the changed content that is displayed on the computing device; the threshold level of change is a predefined difference between the numerical representation of the changed content that is displayed on the computing device and a numerical representation of a previously displayed content; and determining that the quantified operating system-level change satisfies the threshold level of change comprises determining that a difference between the numerical representation of the changed content and the numerical representation of a previously displayed content is greater than or equal to the predefined difference.

Example Clause N, the system of Example Clause L, wherein: the quantified operating system-level change is a contour map of the changed content that is displayed on the computing device; the threshold level of change is a predefined difference between the contour map of the changed content that is displayed on the computing device and a contour map of a previously displayed content; and determining that the quantified operating system-level change satisfies the threshold level of change comprises determining that a difference between the contour map of the changed content and the contour map of a previously displayed content is greater than or equal to the predefined difference.

Example Clause O, the system of Example Clause K, wherein: the operating system-level change is a user input; the quantified operating system-level change is a sequence of user inputs; the threshold level of change is a predefined sequence of user inputs; and determining that the quantified operating system-level change satisfies the threshold level of change comprises determining that the sequence of user inputs matches the predefined sequence of user inputs.

Example Clause P, the system of any one of Example Clause K through O, wherein the operating system-level change is detected in accordance with a predefined set of triggers.

Example Clause Q, the system of Example Clause P, wherein the predefined set of triggers is configured by a user preference of the computing device.

Example Clause R, the system of Example Clause P, wherein the predefined set of triggers is automatically configured based on an analysis of user activity.

Example Clause S, a computer-readable storage medium for triggering a generation of a graphical capture of a desktop environment of a computing device, the computer-readable storage medium having instructions encoded thereon that when executed by the processing system cause the system to perform operations comprising: detecting an operating system-level change in the computing device; categorizing the operating system-level change based on an operating system component that is affected by the operating system-level change; quantifying the operating system-level change utilizing a mechanism selected based on the categorizing of the operating system-level change; determining that the quantified operating system-level change satisfies a threshold level of change that is calculated based on the categorizing of the operating system-level change; in response to determining that the quantified operating system-level change satisfies the threshold level of change, triggering the generation of the graphical capture of the desktop environment recording a current state of the desktop environment; and providing the graphical capture of the desktop environment to a graphical capture consumer.

Example Clause T, the computer-readable storage medium of Example Clause S, wherein the operating system-level change is detected in accordance with a predefined set of triggers.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for triggering a generation of a graphical capture of a desktop environment of a computing device comprising:
detecting an operating system-level change in the computing device;
categorizing the operating system-level change based on an operating system component that is affected by the operating system-level change;
quantifying the operating system-level change utilizing a mechanism selected based on the categorizing of the operating system-level change;
determining that the quantified operating system-level change satisfies a threshold level of change that is calculated based on the categorizing of the operating system-level change;
In response to determining that the quantified operating system-level change satisfies the threshold level of change, triggering the generation of the graphical capture of the desktop environment recording a current state of the desktop environment; and
providing the graphical capture of the desktop environment to a graphical capture consumer.

2. The method of claim 1, wherein:
the operating system-level change is an elapsed time period;
the quantified operating system-level change is a number of seconds of the elapsed time period;
the threshold level of change is a predefined number of seconds; and
determining that the quantified operating system-level change satisfies the threshold level of change comprises determining that the number of seconds of the elapsed time period is greater than or equal to the predefined number of seconds.

3. The method of claim 1, wherein the operating system-level change is a changed content that is displayed on the computing device.

4. The method of claim 3, wherein:
the quantified operating system-level change is a numerical representation of the changed content that is displayed on the computing device;
the threshold level of change is a predefined difference between the numerical representation of the changed content that is displayed on the computing device and a numerical representation of a previously displayed content; and
determining that the quantified operating system-level change satisfies the threshold level of change comprises determining that a difference between the numerical representation of the changed content and the numerical representation of a previously displayed content is greater than or equal to the predefined difference.

5. The method of claim 3, wherein:
the quantified operating system-level change is a contour map of the changed content that is displayed on the computing device;
the threshold level of change is a predefined difference between the contour map of the changed content that is displayed on the computing device and a contour map of a previously displayed content; and
determining that the quantified operating system-level change satisfies the threshold level of change comprises determining that a difference between the contour map of the changed content and the contour map of a previously displayed content is greater than or equal to the predefined difference.

6. The method of claim 1, wherein:
the operating system-level change is a user input;
the quantified operating system-level change is a sequence of user inputs;
the threshold level of change is a predefined sequence of user inputs; and
determining that the quantified operating system-level change satisfies the threshold level of change comprises determining that the sequence of user inputs matches the predefined sequence of user inputs.

7. The method of claim 1, wherein:
the operating system-level change is an application signal;
the quantified operating system-level change comprises determining that the application signal is directed to a trigger application programming interface;
the threshold level of change is a command to the trigger application programming interface to generate a graphical capture; and
determining that the quantified operating system-level change satisfies the threshold level of change comprises determining that the application signal that is directed to the trigger application programming interface is the command to the trigger application programming interface to generate the graphical capture.

8. The method of claim 1, wherein the operating system-level change is detected in accordance with a predefined set of triggers.

9. The method of claim 8, wherein the predefined set of triggers is configured by a user preference of the computing device.

10. The method of claim 8, wherein the predefined set of triggers is automatically configured based on an analysis of user activity.

11. A system for triggering a generation of a graphical capture of a desktop environment of a computing device comprising:
a processing system; and
a computer-readable medium having instructions encoded thereon that when executed by the processing system cause the system to perform operations comprising:
detecting an operating system-level change in the computing device;
categorizing the operating system-level change based on an operating system component that is affected by the operating system-level change;
quantifying the operating system-level change utilizing a mechanism selected based on the categorizing of the operating system-level change;
determining that the quantified operating system-level change satisfies a threshold level of change that is calculated based on the categorizing of the operating system-level change;
in response to determining that the quantified operating system-level change satisfies the threshold level of change, triggering the generation of the graphical capture of the desktop environment recording a current state of the desktop environment; and
providing the graphical capture of the desktop environment to a graphical capture consumer.

12. The system of claim 11, wherein the operating system-level change is a changed content that is displayed on the computing device.

13. The system of claim 12, wherein:
the quantified operating system-level change is a numerical representation of the changed content that is displayed on the computing device;
the threshold level of change is a predefined difference between the numerical representation of the changed content that is displayed on the computing device and a numerical representation of a previously displayed content; and
determining that the quantified operating system-level change satisfies the threshold level of change comprises determining that a difference between the numerical representation of the changed content and the numerical representation of a previously displayed content is greater than or equal to the predefined difference.

14. The system of claim 12, wherein:
the quantified operating system-level change is a contour map of the changed content that is displayed on the computing device;
the threshold level of change is a predefined difference between the contour map of the changed content that is displayed on the computing device and a contour map of a previously displayed content; and
determining that the quantified operating system-level change satisfies the threshold level of change comprises determining that a difference between the contour map of the changed content and the contour map of a previously displayed content is greater than or equal to the predefined difference.

15. The system of claim 11, wherein:
the operating system-level change is a user input;
the quantified operating system-level change is a sequence of user inputs;
the threshold level of change is a predefined sequence of user inputs; and
determining that the quantified operating system-level change satisfies the threshold level of change comprises determining that the sequence of user inputs matches the predefined sequence of user inputs.

16. The system of claim 11, wherein the operating system-level change is detected in accordance with a predefined set of triggers.

17. The system of claim 16, wherein the predefined set of triggers is configured by a user preference of the computing device.

18. The system of claim 16, wherein the predefined set of triggers is automatically configured based on an analysis of user activity.

19. A computer-readable storage medium for triggering a generation of a graphical capture of a desktop environment of a computing device, the computer-readable storage medium having instructions encoded thereon that when executed by the processing system cause the system to perform operations comprising:
detecting an operating system-level change in the computing device;
categorizing the operating system-level change based on an operating system component that is affected by the operating system-level change;
quantifying the operating system-level change utilizing a mechanism selected based on the categorizing of the operating system-level change;
determining that the quantified operating system-level change satisfies a threshold level of change that is calculated based on the categorizing of the operating system-level change;
in response to determining that the quantified operating system-level change satisfies the threshold level of change, triggering the generation of the graphical capture of the desktop environment recording a current state of the desktop environment; and
providing the graphical capture of the desktop environment to a graphical capture consumer.

20. The computer-readable storage medium of claim 19, wherein the operating system-level change is detected in accordance with a predefined set of triggers.
